(19) United States
(12) Patent Application Publication
(10) Pub. No.: US 2021/0369046 A1
(43) Pub. Date: Dec. 2, 2021

(54) FROTHING DEVICE AND METHOD THEREOF

(71) Applicant: Koninklijke Douwe Egberts B.V., Utrecht (NL)

(72) Inventors: Andrew Charles Bentley, Banbury (GB); Harrison Lloyd Woodall, Banbury (GB)

(21) Appl. No.: 17/294,329

(22) PCT Filed: Nov. 11, 2019
(86) PCT No.: PCT/EP2019/080879

§ 371 Date: May 14, 2021

(30) Foreign Application Priority Data
Nov. 20, 2018 (GB) 1818884.7

(51) Int. Cl. A47J 31/44; A23L 2/54

(52) U.S. Cl. CPC A47J 31/4489; A23V 2002/00; A23L 2/54; A47J 31/4496

(57) ABSTRACT

A frothing attachment (1) for a steam wand, the frothing attachment (1) comprising a blade (4) comprising a steam wand connector (2) and further comprising a turbulence generator (6) wherein said turbulence generator protrudes from an outer surface (8) of said blade or comprises a curved part (504) of said blade and is configured to generate turbulence in steam flow exiting a steam wand, in use.

### TECHNICAL FIELD OF THE INVENTION

The present invention relates to frothing attachments for steam wands and steam wands comprising frothing attachments. The present invention further relates to a use of frothing attachments; the use of steam wands; methods of creating a frothed beverage with frothing attachments; and methods of creating a frothed beverage with steam wands. The present invention finally relates to kits comprising a plurality of frothing attachments.

### BACKGROUND TO THE INVENTION

Beverage preparation machines, such as coffee machines, are known to be provided with frothing systems with which a milk container can be associated for warming and/or frothing a milk beverage. The increasing request for the consumption of coffee preparations including a layer of frothed milk, such as, for example, cappuccino, macchiato, flat white and/or latte, has directed the coffee industry to focus on developing new and/or improved frothing systems.

In these known frothing systems, the heating is usually provided via a flow of steam which is sent into the milk container through a steam wand (also called froth wand), to warm and emulsify the milk beverage.

These known steam wands are provided with a steam nozzle comprising multiple apertures of reduced dimensions (orifices), for the exit of the steam flow or steam jet. The presence of multiple orifices ensures that the steam exiting the nozzle is sent in several directions, creating turbulence in the milk and facilitating the formation of a layer of foam on the top surface of the milk beverage.

The layer of foam improves the appeal of the beverage preparation, resulting in a better experience for consumers and a higher customer satisfaction.

These known frothing systems have the disadvantage of being costly and suffer from manufacturing difficulties, due to the very small dimensions of these orifices. In addition, these small orifices can easily clog due to dried residue of milk, generating malfunctions in the steam wand. Furthermore, they require a continuous attention to cleaning to avoid hygiene issues and to avoid potential cross-contamination between two consecutive beverage preparations as the orifices are not easy to clean.

Alternative known frothing systems comprise steam wands provided with a Venturi type frothing system. In these known frothing systems, foam is generated by injecting into the milk beverage a mixture of air and steam accelerated by a Venturi constriction, generating an air/steam jet which reaches the milk beverage allowing turbulence and facilitating a stable formation of fine bubbles.

These known Venturi frothing systems are complex and their manufacture can be costly.

Furthermore, as for the steam nozzles, the reduced dimension of the Venturi restriction can lead to hygiene issues.

It would be therefore advantageous to provide a solution which would mimic the behaviour of the known frothing systems, but provide easy cleaning.

It would be furthermore advantageous to provide a solution which would overcome hygiene issues and cross-contamination between two consecutive uses or preparations.

In addition, it would be advantageous to provide a solution which would ensure a low-cost route to manufacturing, by converting a complex structure as the steam nozzles or Venturi systems into a simplified structure which allows ease of manufacture and assembly.

It would be advantageous to provide a solution which would use different frothing attachments for different milk types in order to ensure the best in-cup quality result in terms of foam for several types of milk (cow, goat, coconut, soy, rice etc.), thereby improving customers satisfaction.

It would be advantageous to provide a solution which would generate different foam structures using different frothing attachments to provide different coffee preparations by selecting the correct frothing attachment.

Finally, it would be advantageous to provide a solution suitable for several beverage preparations comprising coffee, milk, chocolate, tea preparations and/or soups, broths or other food beverages, or the like.

It is therefore an aim of embodiments of the invention to mitigate or overcome at least one problem of the prior art.

### SUMMARY OF THE INVENTION

According to a first aspect of the invention there is provided a frothing attachment for a steam wand comprising a blade comprising a steam wand connector and further comprising a turbulence generator characterised in that said turbulence generator protrudes from an outer surface of said blade or comprises a curved part of said blade and is configured to generate turbulence in steam flow exiting a steam wand, in use.

In some embodiments, the frothing attachment may be configured such that the turbulence generator may intercept steam exiting a steam wand, to which it is connected.

The frothing attachment may comprise a steam wand connector configured to detachably connect said blade to a steam wand in use.

In some embodiments, the steam wand connector may comprise a steam channel, which may configured to allow fluid communication between a steam wand and the turbulence generator in use.

The steam wand connector may comprise a bayonetted and/or a threaded connection and/or a resilient clamp.

In some embodiments, the frothing attachment may be made of a polymeric material. The polymeric material may comprise polypropylene (PP), polyethylene (PE), polyethylene terephthalate (PET), polylactic acid (PLA), polyamide (PA), polycarbonate (PC), elastomers, rubbers, polysiloxanes and/or a combination thereof. The polymeric material may comprise decomposable material and/or biodegradable material, for example polyhydroxyalkanoates (PHAs).

In some embodiments, the frothing attachment may be configured to be disposable after no more than five uses, preferably after single use.

In some embodiments the frothing attachment may be made of a metal, such as stainless-steel.

According to a second aspect of the invention there is provided a steam wand comprising a steam channel and further comprising a frothing attachment of the first aspect of the invention.

The steam wand may comprise a connection portion connectable to the frothing attachment. The connection portion may comprise a bayonetted and/or a threaded connection and/or a resilient clamp. The connection portion is configured to connect to the steam wand connector of the frothing attachment.

In embodiments in which the steam wand connector of the frothing attachment comprises a steam channel, this may be arranged to form a continuous steam channel with the steam channel of the steam wand.

According to a third aspect of the invention there is provided a steam wand comprising a steam channel having a steam inlet, a steam outlet and comprising a blade extending therefrom characterised in that said blade includes a turbulence generator protruding therefrom.

The steam channel, blade, steam channel inlet and/or outlet may be as described according to the first or second aspect of the invention. The steam channel, blade, the steam channel inlet and/or outlet may be an integral part of the steam wand.

The following statements apply equally to the first, second and third aspects of the invention.

In some embodiments the steam channel may comprise a steam channel inlet and a steam channel outlet spaced apart from said steam channel inlet. The steam channel may be at least partially adjacent to said blade. In further embodiments, the blade may be at least partially pendent beyond said steam channel outlet.

The blade may comprise a length equal or shorter than the steam channel.

In some embodiments, the blade may comprise at least one wing protruding from the blade, and the at least one wing may extend beyond the steam wand connector.

In some embodiments, the blade may comprise a turbulence generator in the form of a baffle on an outer surface of the blade.

The turbulence generator may be positioned on the perimeter of the outer surface of the blade.

In some embodiments, the turbulence generator may be configured such that it is directly or indirectly in the flow path of the steam flow exiting a steam wand in use. The turbulence generator may modify the direction of a steam flow exiting a steam wand, in use.

In some embodiments, the turbulence generator in the form of a baffle may comprise an at least a partially flat, cuneate, wedge and/or tapered shape, protruding from the outer surface of the blade.

In some embodiments, the baffle may be in the shape of a cube, a rectangular prism, a triangular prism, a pyramid prism, a sphere, a hemi-sphere, a disk and/or a sector of a circle.

The blade may comprise a plurality of turbulence generators. The plurality of turbulence generators may be arranged in a random or ordered matrix.

In some embodiments, the blade may comprise a droplet shape, a needle and/or rod shape.

The blade may comprise a curved portion at the distal end thereof. The curved portion may be configured to directly intercept a steam flow exiting a froth wand in use.

In some embodiments, the distal end of the curved portion of the blade may directly intercept steam flow exiting a steam wand to which the blade is attached. In addition, the curved portion may taper towards its distal end. The curved portion may be directly under the steam outlet of the frothing attachment and/or steam wand.

In some embodiments the curved portion may curve inwardly towards the steam outlet of the steam channel.

In some embodiments, the partially curved portion may curve outwardly in a spoon-shaped or a bell-shaped curve and indirectly intercept steam flow exiting a steam wand, in use.

The curved portion may have a width and/or diameter and/or thickness less than the outer diameter of the steam channel.

In some embodiments the blade may comprise a hooked shape.

Furthermore, a portion of the turbulence generator may be located at the largest width of the blade and the blade may comprise a square and/or an elongate and/or a circular and/or a rectangular and/or a cuneate shape.

According to a fourth aspect of the invention there is provided a use of a frothing attachment of the first aspect of the invention on a steam wand of a beverage preparation machine.

According to a fifth aspect of the invention there is provided a use of the steam wand of the third aspect of the invention on a beverage preparation machine.

According to a sixth aspect of the invention there is provided a method of creating a frothed beverage with a frothing attachment of the first aspect of the invention comprising the steps of:
coupling said frothing attachment to a steam wand for frothing a beverage; and
supplying steam through said steam wand into said beverage.

According to a seventh aspect of the invention there is provided a method of creating a frothed beverage with a steam wand of the third aspect of the invention comprising the step of:
coupling said steam wand to a steam source for frothing a beverage; and
supplying steam through said steam wand into said beverage.

In some embodiments, the method further comprises the steps of:
decoupling said steam wand; and
using said steam wand as a stirrer and/or a spoon.

According to an eighth aspect of the invention there is provided a kit comprising a plurality of frothing attachments of the first aspect of the invention for frothing liquids with different fat contents.

### DETAILED DESCRIPTION OF THE INVENTION

In order that the invention may be more clearly understood, embodiments thereof will now be described, by way of example only, with reference to the accompanying drawings of which:

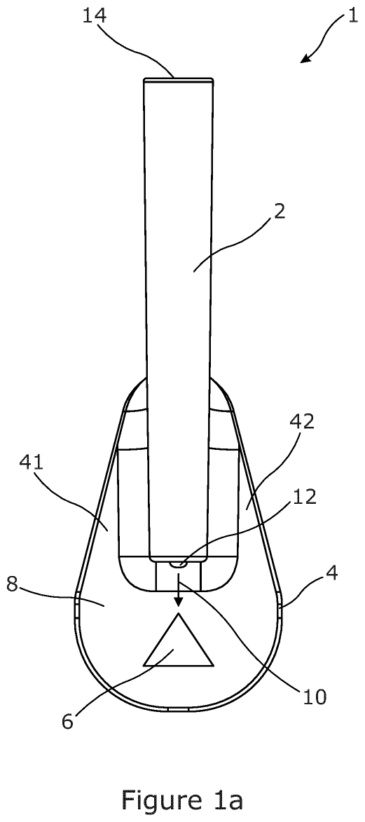

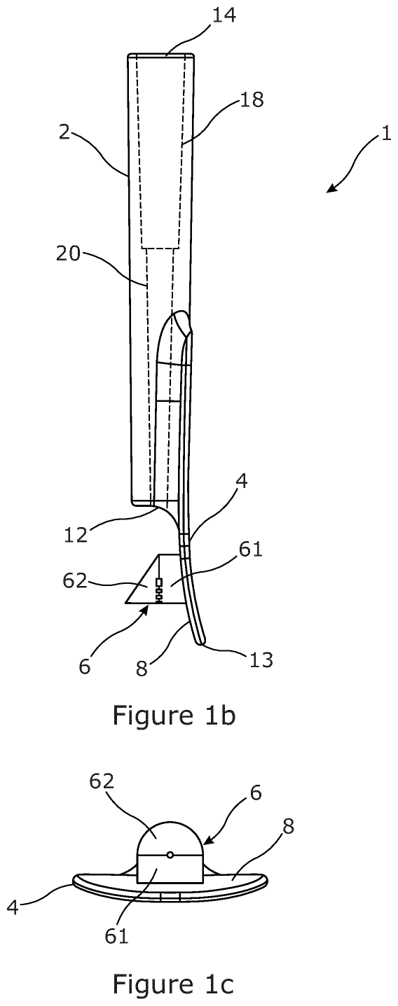

FIG. 1a illustrates a front view of a first embodiment of a frothing attachment according to a first aspect of the invention;

FIG. 1b illustrates a side view of the first embodiment of the frothing attachment of FIG. 1a according to the first aspect of the invention;

FIG. 1c illustrates a bottom end view of the first embodiment of the frothing attachment of FIG. 1a according to the first aspect of the invention;

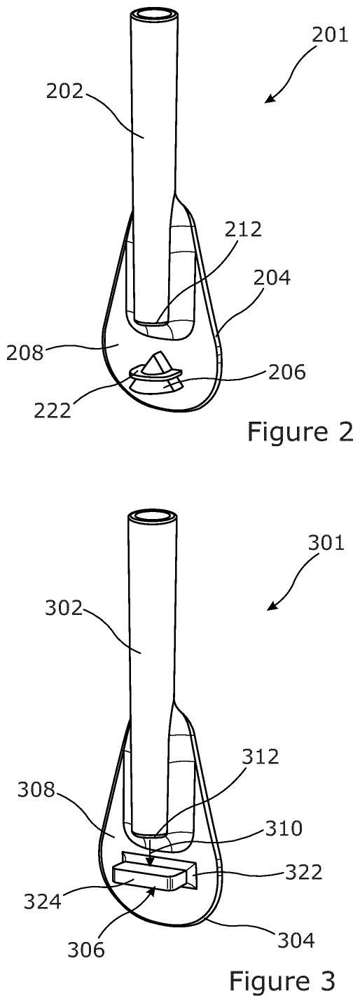

FIG. 2 illustrates a perspective view of a first alternative embodiment of a frothing attachment of FIG. 1a according to the first aspect invention;

FIG. 3 illustrates a perspective view of a second alternative embodiment of a frothing attachment of FIG. 1a according to the first aspect invention;

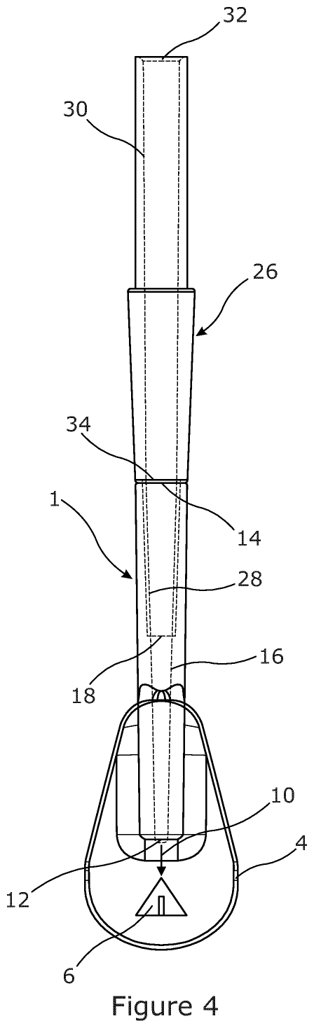

FIG. 4 illustrates a front view of an assembly of a frothing attachment of FIG. 1a and a steam wand according to the second aspect of invention;

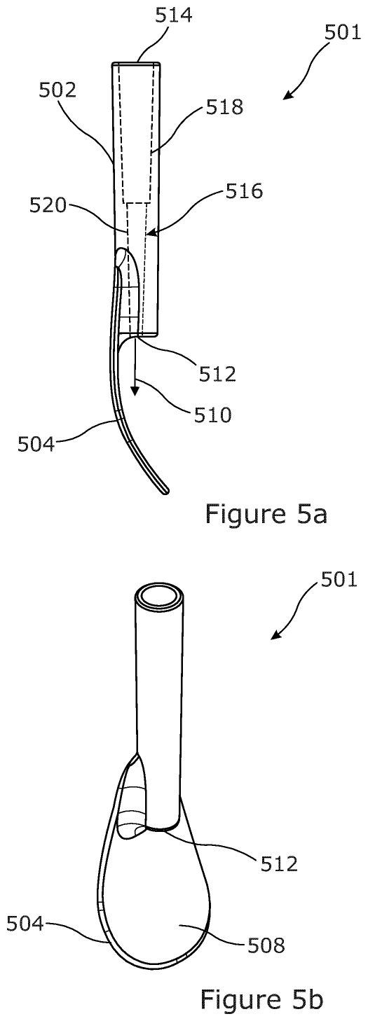

FIG. 5a illustrates a side view of another embodiment of a frothing attachment according to the first aspect of invention;

FIG. 5b illustrates a perspective view of the frothing attachment of FIG. 5a according to the first aspect of invention;

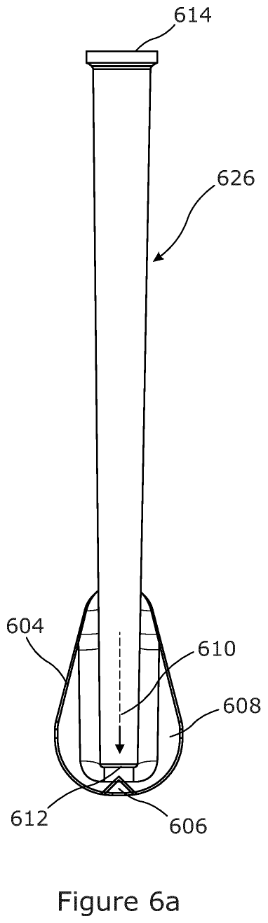

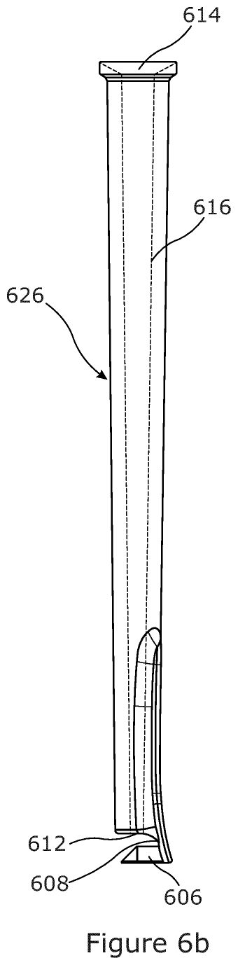

FIG. 6a illustrates a front view of a steam wand according to a third aspect of the invention;

FIG. 6b illustrates a front side view of the steam wand of FIG. 6a;

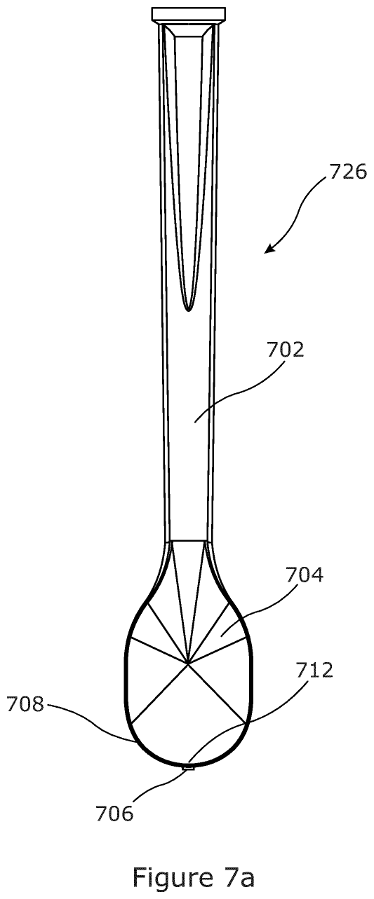

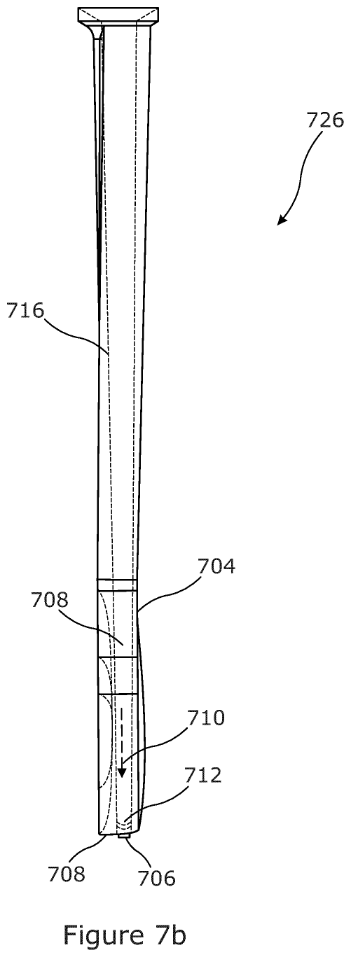

FIG. 7a illustrates a front view of a steam wand according to the third aspect of the invention;

FIG. 7b illustrates a side view of a steam wand of FIG. 7a according to the third aspect of the invention.

Referring to the Figures, like numbers represent like components.

Referring firstly to FIGS. 1a and 1b an embodiment of a frothing attachment (1) for a steam wand is shown.

The embodiment comprises a frothing attachment (1) comprising a steam wand connector (2) comprising a steam channel (16) (as shown in FIG. 1b), a blade (4) adjacent and pendent from said wand connector (2), a turbulence generator in the form of baffle (6), protruding from an outer surface (8) of said blade (4) and positioned on the trajectory between a steam channel outlet (12) of the steam wand connector (2) and the blade distal end (13), in order to intercept a steam flow direction (10) of a steam flow (not shown) exiting from the steam channel outlet (12). The steam channel outlet (12) is in the form of a reduced orifice located at a distal end of the wand connector (2) adjacent to the blade (4). A steam flow inlet (14) in the form of an aperture is positioned at the opposite end of the steam wand connector (2), allowing the steam flow to enter the frothing attachment (1) when attached to a conventional steam wand (not shown). The blade (4) has a paddle-like structure generated by a first wing (41) and a second wing (42) projecting from the wand connector (2).

Referring to FIG. 1b, a dotted line represents an internal steam channel (16) which extends the entire length of the wand connector (2) of a frothing attachment (1) fluidly connecting the ends of the wand connector (2) itself, i.e. the steam inlet (14) and the steam outlet (12). The steam channel (16) is divided in two segments: a first steam channel segment (18) and a second steam channel segment (20) adjacent and in fluid communication with the first steam channel segment (18).

A turbulence generator in the form of a baffle (6) protrudes from an outer surface (8) of the blade (4), and consists of a first baffle portion (61) and a second baffle portion (62).

The first steam channel segment (18) extends between and is directly connected to the steam channel inlet (14) and the second steam channel segment (20). The second steam channel segment (20) extends between and is directly connected to the first steam channel segment (18) and the steam channel outlet (12). Both steam channel segments (18, 20) are tapered toward the steam channel outlet (12), decreasing their diameters along the steam flow direction (10). Particularly the first channel segment (18) can be tapered, in some embodiments. The tapering range may vary from 0° to 10°, while the second channel segment (20) may be tapered.

The outlet diameter (12) is in the range of 0.1 to 8 mm, particularly 1 to 6 mm, preferably 1.5 to 5 mm, more preferably 1.8 mm.

In alternative embodiments the steam channel (16) is not segmented and it is tapered continuously along the steam flow direction (10). The entire length of the steam channel (16) may be in the range of 5 cmmm to 20 cm.

The first steam channel portion (18) of the embodiment of FIG. 1b is tapered in such a way to allow the connection with a reciprocal tapered connection portion on a steam wand of a beverage preparation machine, by means of a snap-on mechanism, but any alternative fastening and/or connection means can be used, such as for instance clamping, dowel pins, flanged, edged, threaded and/or bayonetted connections.

The blade (4) is adjacent to and pendent from the wand connector (2) at the distal end where the steam channel outlet (14) is located. The blade (4) can be attached to the wand connector (2) through a standard connection means as for example clamping, snap-on, gluing, and/or moulding or may be integral with the wand connector.

The blade (4) comprises a paddle-like structure which consists of the two wings (41, 42) extending from the wand connector (2). The distal end (13) of the blade (4) bends outwardly and away from the steam flow direction (10), conferring to the paddle-like structure of the blade (4) a collecting shape typical of a spoon which allows consumers to taste the generated foam directly from and with the frothing attachment (1) when it is removed from the steam wand.

In other embodiments the distal end (13) of the blade (4) bends towards the steam flow direction (10).

The blade (4) may also be planar-pendent from the wand connector (2) beyond the steam channel outlet (12) and parallel with the steam flow direction (10),

The blade (4) can comprise a drop-like, squared, triangular, circular, hemi-circular, rectangular shape.

The baffle (6) is adjacent and attached to the blade (4) through a standard integral moulding or connection process, such as for example clamping, snap-on, gluing, and/or moulding.

The baffle (6) projects from the blade outer surface (8) substantially perpendicularly to the steam flow direction (10) in such a way to intercept the steam flow exiting from the steam channel outlet (12).

The first baffle portion (61) attached to the blade outer surface (8) is in the form of a prism. The second baffle portion (62) in the form of a hemi-cone, is attached to the first baffle portion (61) in such a way that the apex of the hemi-cone faces the steam channel outlet (12). Particularly, the apex of the hemi-cone intercepts the steam flow direction (10) of the steam flow.

The first and second baffle portions (61, 62) are integrally formed as they are obtained through the same moulding process, but any alternative suitable assembling process can be used.

In other embodiments the shape of the baffle (6) may also comprise alternative shapes, such as, for example, flat, cuneate, wedge and/or tapered shapes.

In alternative embodiments, multiple baffles (not shown) can be used; and these can be positioned in a random disposition or in an ordered pattern.

The frothing attachment (1) can consist of metal and/or plastic substrates, for example stainless steel and/or polypropylene (PP), polyethylene (PE), polyethylene terephthalate (PET), and/or polylactic acid (PLA), polyamide (PA), polycarbonate (PC), elastomers, rubbers, polysiloxanes and/or a combination thereof. The polymeric material can also comprise decomposable material and/or biodegradable material, for example polyhydroxyalkanoates (PHAs)

When the frothing attachment (1) consists of plastic substrate any suitable process of manufacturing can be used, as for example a standard injection moulding process and/or 3D printing process.

In case the frothing attachment (1) is made of metal substrate, processes like casting, forming and/or machining can be used.

Referring now to FIG. 1c a bottom view of the frothing attachment (1) of FIG. 1a is shown.

The baffle (6) protrudes laterally from an outer surface (8) of a blade (4). One surface of the first baffle portion in the form of a prism (61) is directly attached to the outer surface (8) of the blade (4) by means of standard connecting processes such as a moulding process, the second baffle portion in the form of a hemi-cone (62) is adjacent and fixedly connected to an opposite surface (not shown) of the first baffle portion in the form of a prism (61). The largest diameter of the hemi-cone (62) is directed towards the blade distal end (13).

In use, the frothing attachment (1) is connected to a standard steam wand (not shown) of a beverage preparation machine and it is placed inside the volume of a beverage preparation ready to be frothed (for instance a cold milk beverage). The frothing attachment (1) is then connected to the steam wand through reciprocal tapered portions located on the frothing attachment (1) and the steam wand itself, but any standard fastening and/or connecting means in the form for example of clamping, snap-on, o-ring, dowel pins, flanged, edged, threaded and/or bayonetted connections can be used, applying them to the steam wand itself and/or to the steam flow inlet (14) of the frothing attachment (1) and/or to both. The standard steam wand is itself connected to a steam outlet of a beverage preparation machine (not shown) via standard connections, to produce a frothed milk beverage. When steam is generated and sent to the steam outlet of the beverage preparation machine it enters the steam wand and through the steam channel inlet (14) it reaches the steam channel (16) of the frothing attachment (1). The steam then flows through the entire length of the steam channel (16) to exit the frothing attachment (1) from the steam channel outlet orifice (12). The steam flow exiting the frothing attachment (1) reaches the baffle (6) which at least partially deviates the steam flow direction (10) generating turbulence in the steam jet which agitates the milk beverage, facilitating air inclusion in such a way that a fine bubble structure called “micro foam” is generated with improved bubbles stability.

Referring now to FIG. 2 another embodiment of a frothing attachment (201) according to the first aspect of the invention is shown.

The embodiment comprises a wand connector (202), a blade (204) pendent from the wand connector (202) beyond a steam channel outlet (212) and a turbulence generator in the form of a baffle (206) protruding from an outer surface (208) of the blade (204) and comprising a toroid structure (222) projecting therefrom.

The baffle (206) is in the form of a prism as described in FIGS. 1a to 1c additionally comprising a flat toroid structure (222) projecting around the outer surface of the baffle (206) itself. The toroid structure is directly attached to the outer surface (208) of the blade (204) such that it's top surface is substantially perpendicular to the steam flow direction.

Referring now to FIG. 3 an alternative frothing attachment (301) according to the first aspect of the invention is shown.

The embodiment comprises a wand connector (302), a blade (304) extending from the wand connector (302) and pendent beyond a steam channel outlet (312) and a turbulence generator in the form of a baffle (306) protruding from an outer surface (308) of the blade (304) and consisting of two portions: a squared based pyramid with a flat top (322) surmounted by a cuboid shape (324). The baffle (306) is positioned on the blade (304) in such a way to intercept a steam flow direction (310).

The baffle (306) is in the form of a squared based pyramid with a flat top (322), where the larger base of the pyramid is directly attached to the outer surface (308) of the blade (304) and the smaller flat top is shared with a cuboid shape (324) protruding therefrom toward the steam flow direction (310) in order to intercept it.

Both embodiments of FIGS. 2 and 3 can be manufactured through standard manufacturing processes such as for instance moulding processes when made of plastic substrates (i.e. for example polypropylene (PP), polyethylene (PE), polyethylene terephthalate (PET), and/or polylactic acid (PLA), polyamide (PA), polycarbonate (PC), elastomers, rubbers, polysiloxanes, polyhydroxyalkanoates (PHAs) and/or a combination thereof. Any alternative suitable manufacturing method can be used.

If the embodiment is provided in a metal substrate (for example stainless steel) any suitable manufacturing processes can be used, as for example casting, forming and/or machining.

In use, the embodiments of FIGS. 2 and 3 operate as described for the embodiments of FIGS. 1a to 1c. When the frothing attachments (201, 301) of FIGS. 2 and/or 3 are connected to a standard steam wand of a standard coffee beverage preparation machine and steam is sent through the steam wand, the connected frothing attachment (201, 301) allows the steam to reach the steam outlet (212, 312) via the steam channel. The steam flow direction (210, 310) is deviated by the turbulence generator in the form of baffle (206, 306) protruding from the outer surface of the blade beyond the steam outlet (212, 312). The baffle (206, 306) deviates the steam flow direction (210, 310) creating turbulence inside the beverage to be frothed and a layer of fine froth containing micro bubbles is generated.

Referring to FIG. 4 an assembly of a frothing attachment (1) of FIGS. 1a to 1c and a steam wand (26), according to the second aspect of the invention, is shown.

In this embodiment a steam wand (26) comprises a distal end tapered portion (28) which matches a tapered segment (18) of a steam channel (16) of a frothing attachment (1) in order to allow connection and fluid communication between the steam wand (26) and the frothing attachment (1) itself. The steam wand (26) comprises a wand internal channel (30) extending between its ends, the ends forming a steam wand inlet (32) connectable to a beverage preparation machine (not shown) and a steam wand outlet (34) connectable to the frothing attachment (1) through the two tapered portions (18, 28). A steam flow channel (16) internal to the frothing attachment (1) allows the steam flow (not shown) to reach the steam channel outlet (12) of the frothing attachment (1). A steam flow direction (10) is deviated by a turbulence generator in the form of a baffle (6) positioned beyond the steam channel outlet (12).

In use the frothing attachment (1) is connected to the steam wand (26) via the reciprocal tapered portions (18, 28). The steam flow generated by the beverage coffee machine is then sent to the steam channel outlet (12) through the steam channel (16). The steam flow direction (10) is then deviated by the baffle (6) creating turbulence inside the beverage to be frothed and a layer of fine froth constituted of micro bubbles is generated.

Referring now to FIG. 5a a side view of another embodiment of a frothing attachment (501) of the first invention is shown.

A steam wand connector (502) is attached to a blade (504) through conventional manufacturing process. The blade (504) has a spoon-like shape and is pendent from the wand connector (502) beyond a steam channel outlet (512) in such a way that it intercepts a steam flow direction (510) of a steam flow (not shown) exiting the steam channel outlet (512). The blade (504) pending from a wand connector (502) bends inwardly towards the steam flow direction (510). The wand connector (502) comprises a steam channel (516) comprising two differently tapered sections (518, 520) and a steam inlet (514) which engages a steam wand of a beverage preparation machine (not shown) to prepare frothed beverages.

The embodiment of FIG. 5b is a perspective view of the frothing attachment (501) of FIG. 5a.

The blade (504) is pendent from the wand connector (502) beyond the steam channel outlet (512) with a spoon-like shape which creates a collecting outer surface (508) which allows a consumer to collect and taste the generated foam directly from and with the frothing attachment (501).

The frothing attachment (501) of FIGS. 5a to 5b is made of plastic substrate such as polypropylene (PP), polyethylene (PE), polyethylene terephthalate (PET), and/or polylactic acid (PLA), polyamide (PA), polycarbonate (PC), elastomers, rubbers, polysiloxanes and/or a combination thereof. The polymeric material can comprise decomposable material and/or biodegradable material such as polyhydroxyalkanoates (PHAs).

The blade (504) is attached to the wand connector (502) through known manufacturing processes as for example by means of a moulding process, but any alternative suitable process can be used for example, clamping, snap-on and/or gluing.

Alternatively, it can be made of metal substrate such as stainless steel, by means of standard manufacturing processes.

In use, once the frothing attachment (501) is connected to a steam wand of a beverage preparation machine a steam flow is sent through the steam channel (516) to the steam channel outlet (512) where the steam flow direction (10) is deviated by the cured front face outer surface (508) of the spoon-like blade (504) to create turbulence which generates a layer of fine froth constituted of micro bubbles.

FIG. 6a represents a steam wand (626) of the third aspect of the invention, comprising a steam channel (616) having a steam inlet (614), a steam outlet (612) and comprising a blade (604) extending therefrom. Said blade (604) includes a turbulence generator in the form of a baffle (606) protruding from an outer surface (608) of the blade (604).

Referring to FIG. 6b a side view of a steam wand (626) of FIG. 6a is represented. The steam channel (616), as shown in dotted lines in FIG. 6b, extends from the steam inlet (614) to the steam outlet (612) positioned at opposed distal ends of a steam wand (626). The blade (604) protruding beyond the steam channel outlet (614) comprises a turbulence generator in the form of a baffle (606) projecting from an outer surface (608) of the blade (604) in order to intercept a steam flow direction (610) of the steam flow (not shown) exiting the steam outlet (614).

The steam wand (626) of FIGS. 6a and 6b can be made of plastic substrate such as polypropylene (PP), polyethylene (PE), polyethylene terephthalate (PET), and/or polylactic acid (PLA), polyamide (PA), polycarbonate (PC), elastomers, rubbers, polysiloxanes and/or a combination thereof. The polymeric material can also comprise decomposable material and/or biodegradable material (such as for example polyhydroxyalkanoates (PHAs). The blade (604) is attached to the steam wand (626) through known manufacturing processes as for instance by means of a moulding process, but any alternative suitable process can be used for example, clamping, snap-on and/or gluing.

Alternatively, the steam wand (626) can be made of metal substrate as for example stainless steel by means of standard manufacturing processes.

In use after having connected the steam wand (626) to a steam exit of a standard coffee beverage preparation machine, steam flow is sent through the steam wand (626) to the steam channel outlet (612) where it is deviated by the turbulence generator in the form of a baffle (606) which protrudes from the outer surface (608) of the blade (604) beneath the steam channel outlet (612); this generates turbulence inside the beverage to be frothed and creates a layer of fine froth constituted of micro bubbles.

Referring to FIGS. 7a and 7b a steam wand (726) comprising a blade (704), a steam wand connector (702), a steam channel (716), a steam channel outlet (712) and a turbulence generator in the form of a cone (706) is shown. The cone deviates a steam flow direction (not shown) exiting the steam wand (726) from the steam channel outlet (712). The turbulence generator in the form of a cone (706) protrudes from an outer, bottom surface (708) of the blade (704).

The turbulence generator in the form of a cone (706) can be fixedly attached to the blade (704) by means of standard connection means for instance gluing, moulding process, or alternatively can be removably attached to the blade (704) by means of a snap-on process for instance.

In use once the turbulence generator in the form of a cone (706) is attached to the steam channel outlet (712) of the steam wand (726), the steam wand (726) is then connected to the steam exit of a standard coffee preparation machine and steam is sent through the steam wand (726) to the steam channel outlet (712). The cone (706) intercepts and deviates the steam flow direction generating turbulence inside the beverage to be frothed and creating a layer of fine froth constituted of micro bubbles.

The above embodiments are described by way of example only. Many variations are possible without departing from the scope of the invention as defined in the appended claims.

1. A frothing attachment for a steam wand, the frothing attachment comprising a blade comprising a steam wand connector and further comprising a turbulence generator wherein said turbulence generator protrudes from an outer surface of said blade or comprises a curved part of said blade and is configured to generate turbulence in steam flow exiting a steam wand, in use.

2. A frothing attachment according to claim 1 wherein said attachment is configured such that the turbulence generator directly intercepts steam exiting a steam wand, to which it is connected in use.

3. A frothing attachment according to claim 1 or 2 wherein said steam wand connector is configured to detachably connect said blade to a steam wand, in use.

4. A frothing attachment according to claim 1 wherein said steam wand connector comprises a steam channel configured to allow fluid communication between a steam wand and said turbulence generator, in use.

5. A frothing attachment according to claim 4 wherein said steam channel is at least partially adjacent to said blade.

6. A frothing attachment according to claim 4 wherein said blade is at least partially pendent beyond said steam channel.

7. A frothing attachment according to claim 1 wherein said blade comprises a turbulence generator in the form of a baffle on an outer surface of said blade.

8. A frothing attachment according to claim 1 wherein said turbulence generator is positioned on the perimeter of said outer surface of said blade.

9. A frothing attachment according to claim 1 wherein said turbulence generator is located set-in from the perimeter of an outer surface of said blade.

10. A frothing attachment according to claim 1 wherein said turbulence generator modifies the direction of a steam flow exiting a steam wand, in use.

11. A frothing attachment according to claim 1 wherein said turbulence generator comprises a curved portion of the distal end of the blade.

12. A frothing attachment according to claim 11 wherein said curved portion is configured to directly intercept a steam flow exiting a froth wand, in use.

13. A frothing attachment according to claim 11 wherein at least a distal end of said curved portion of said blade directly intercepts steam flow exiting a steam wand, to which it is attached, in use.

14. A frothing attachment according to claim 11 wherein said curved portion tapers towards its distal end.

15. A frothing attachment according to claim 11 wherein said steam wand connector comprises a steam channel configured to allow fluid communication between a steam wand and said turbulence generator, in use, and wherein said at least partially curved portion curves inwardly towards the steam outlet of the steam channel.

16. A frothing attachment according to claim 1 wherein at least a portion of said turbulence generator is located at the largest width of said blade.

17. A frothing attachment according to claim 1 wherein said steam wand connector comprises a bayonetted and/or a threaded connection and/or a resilient clamp.

18. A steam wand comprising a frothing attachment according to claim 1.

19. A steam wand comprising a steam channel having a steam inlet, a steam outlet and comprising a blade extending therefrom wherein said blade includes a turbulence generator protruding therefrom.

20. Use of a frothing attachment according to claim 1 on a steam wand of a beverage preparation machine.

21. Use of the steam wand of claim 18 on a beverage preparation machine.

22. A method of creating a frothed beverage with a frothing attachment according to claim 1 comprising the steps of:
coupling said frothing attachment to a steam wand for frothing a beverage; and
supplying steam through said steam wand into said beverage.

23. A method of creating a frothed beverage with a steam wand according to claim 18 comprising the steps of:
coupling said steam wand to a steam source for frothing a beverage; and
supplying steam through said steam wand into said beverage.

24. A method according to claim 23 wherein said method further comprises further steps of:
decoupling said steam wand; and
using said steam wand as a stirrer and/or a spoon.

25. A kit comprising a plurality of frothing attachments of claim 1 with different turbulence generators and/or blade shapes, for frothing liquids with different fat contents.
